(19) United States
(12) Patent Application Publication
(10) Pub. No.: US 2022/0222656 A1
(43) Pub. Date: Jul. 14, 2022

(54) BATCH PROCESSING OF CRYPTOCURRENCY TRANSACTIONS USING UNSPENT TRANSACTION OUTPUTS

(71) Applicant: Bitaccess Inc, Ottawa (CA)

(72) Inventors: Mohammed Adham, Ottawa (CA); Dylan Seago, Knoxville, TN (US)

(21) Appl. No.: 17/149,658

(22) Filed: Jan. 14, 2021

(51) Int. Cl. G06Q 20/36; H04L 9/14; H04L 9/30

(52) U.S. Cl. CPC G06Q 20/3678; H04L 9/14; H04L 2209/56; G06Q 2220/00; H04L 9/3006

(57) ABSTRACT

Systems and methods describe providing batch processing of blockchain-based cryptocurrency transactions. First, the system receives or derives a number of public keys each associated with a digital wallet for cryptocurrency, then maintains a communication path to each digital wallet using the public keys. The system receives a transaction request from each digital wallet, then generates a transaction containing transaction details for each digital wallet. A request is sent to each digital wallet in the transaction to verify the transaction details for that digital wallet, and signature are received from each digital wallet based on the request to verify the transaction details for that digital wallet. Upon receiving signatures from each of the digital wallets, the system broadcasts the transaction at a blockchain network.

### FIELD OF THE INVENTION

The present invention relates generally to financial transactions, and more particularly, to systems and methods for providing batch processing of cryptocurrency transactions using unspent transaction outputs.

### BACKGROUND

Within blockchain-based cryptocurrency, value for the cryptocurrency is transferred on a blockchain network via transactions. Due to the nature of blockchain-based cryptocurrencies such as Bitcoin, wherein transactions must be verified by miners operating at capacity, there is an overhead cost (e.g., miner's fees) associated with every transaction. Businesses wishing to conduct transactions on the blockchain typically must transact within a specific timeframe, which can be quite expensive given these transaction costs. This is due to competition with others transacting for a fixed resource which operates on a network with a finite capacity.

Within some such cryptocurrency transactions, balances in the network are kept in the form of unspent transaction outputs (“UTXOs”), such that transactions are created by consuming available UTXOs from a digital wallet or other cryptocurrency keychain (hereinafter “keychain”). Currently, if a person or entity would like to send a single transaction in a cryptocurrency based on unspent transaction outputs (“UTXOs”), they would need to accumulate many UTXOs in their keychain, create a full transaction by selecting UTXOs as inputs, include change outputs and a header, and broadcast said transaction to the network. The overhead resulting from the input UTXOs typically account for 50-75% of single output transaction cost, with a significant amount of the transaction being wasted space if just a single output (i.e., a single destination wallet address or single recipient) is needed for the transaction. For example, a typical cost breakdown of a transaction with 1 input, 1 output, and 1 change output may amount to 66% for the input, 15% for the output, 15% for the change output, and 4% for the header. On UTXO-based blockchains, many implementations allow for hundreds of inputs and outputs to be bundled together in a single transaction, which can reduce the overhead of a single input/output pair. This is known as “batching” or “batch processing”. As inputs remain roughly constant while outputs increase during this batching, both the input and header share decrease, resulting in a better cost per output. Highly active keychain wallets can thus implement this batching to reduce overhead.

Large companies can mitigate the costs of UTXO-based transactions by batching many transactions together on a periodic basis, thereby bundling all of these transactions into a single one. This leads to a lower cost of output for such large companies with highly active keychain wallets. Smaller entities, on the other hand, do not have as highly active keychains, as they send comparatively infrequent UTXO transactions. A small company with only 1-2 transactions per hour or per day, for example, has to pay a higher cost per output and is unable to exploit the same batching techniques which are available to large companies. Instead, they are forced to significantly delay transactions until sufficient outputs are available to justify a full transaction.

Merging UTXOs into a single transaction also has the effect of directly correlating the input transactions together. This significantly reduces the privacy of the transactions, and enables entities to perform large scale data analysis and cluster transactions together. The net effect of this is that the total receivables and spending of a keychain is visible, which is undesirable for many businesses.

There are some implementations of merged UTXO-based transactions across keychains, which are commonly referred to as CoinJoin. However, these are suited to strictly address privacy concerns. Since these designs preclude centralization and identification, they are not optimized for speed and efficiency.

Thus, there is a need in the field of financial transactions to create new and useful systems and methods for providing batch processing of blockchain-based cryptocurrency transactions involving UTXOs. The source of the problem, as discovered by the inventors, is a lack of centralization and identification, and a lack of asynchronous management of multiple parties signing transactions.

### SUMMARY

The invention overcomes the existing problems by enabling entities which send infrequent UTXO transactions to implement batching techniques which larger entities have been able to exploit. The invention utilizes a centralized software implementation, wherein each keychain or digital wallet is registered for transaction creation. Registration involves the submission of a hierarchically derived public key, which enables the server to monitor the entire keychain for inputs. Once the system receives a number of public keys associated with digital wallets, it maintains a communication path to each digital wallet. The system then receives a transaction request from each digital wallet. Based on the transaction requests, the system generates a transaction, including transaction details for each digital wallet. The transaction includes a number of outputs associated with additional digital wallets. The system sends a request to each digital wallet in the transaction to verify the transaction details for that digital wallet, then receives a signature from each digital wallet based on the request to verify for that wallet. Finally, upon receiving signatures from each of the digital wallets, the system broadcasts the transaction at a blockchain network.

In some embodiments, the system generates the transaction in part by identifying one or more of the outputs having a shared destination, and merging those outputs into a single output associated with the shared destination.

In some embodiments, the system apportions fees for the transaction to the digital wallets associated with the transaction requests by sharing the fees proportionally among the digital wallets according to the amount of transaction space used.

In some embodiments, each digital wallet is associated with a ranking representing the reliability of the digital wallet in signing transactions. In some embodiments, upon a predefined period of time passing without receiving a signature from a digital wallet in the transaction, modifying the ranking of the digital wallet to indicate a decreased reliability of the digital wallet in signing transactions. In some embodiments, one or more of the wallets may be removed from future transactions based on their associated rankings. In some embodiments, the transaction may be rebroadcast with a higher transaction fee upon the signatures failing to be obtained. In some embodiments, conversely, digital wallets that did sign the transaction may have their rankings modified to be increased, indicating increased reliability of the digital wallet in signing transactions.

Further areas of applicability of the present disclosure will become apparent from the detailed description, the claims and the drawings. The detailed description and specific examples are intended for illustration only and are not intended to limit the scope of the disclosure.

### BRIEF DESCRIPTION OF THE DRAWINGS

The present disclosure will become better understood from the detailed description and the drawings, wherein:

FIG. 1A is a diagram illustrating an exemplary environment in which some embodiments may operate.

FIG. 1B is a diagram illustrating an exemplary computer system that may execute instructions to perform some of the methods herein.

FIG. 2A is a flow chart illustrating an exemplary method that may be performed in some embodiments.

FIG. 2B is a flow chart illustrating additional steps that may be performed in accordance with some embodiments.

FIG. 3A is a flow chart illustrating an example flow for generating a new transaction after a failed or aborted attempt to complete a transaction, in accordance with some embodiments.

FIG. 3B is a flow chart illustrating an example flow for generating and successfully broadcasting a transaction, in accordance with some embodiments.

FIG. 3C is a flow chart illustrating an example flow for confirming that a transaction has been completed, in accordance with some embodiments.

FIG. 4 is a diagram illustrating an exemplary computer that may perform processing in some embodiments.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

I. Exemplary Environments

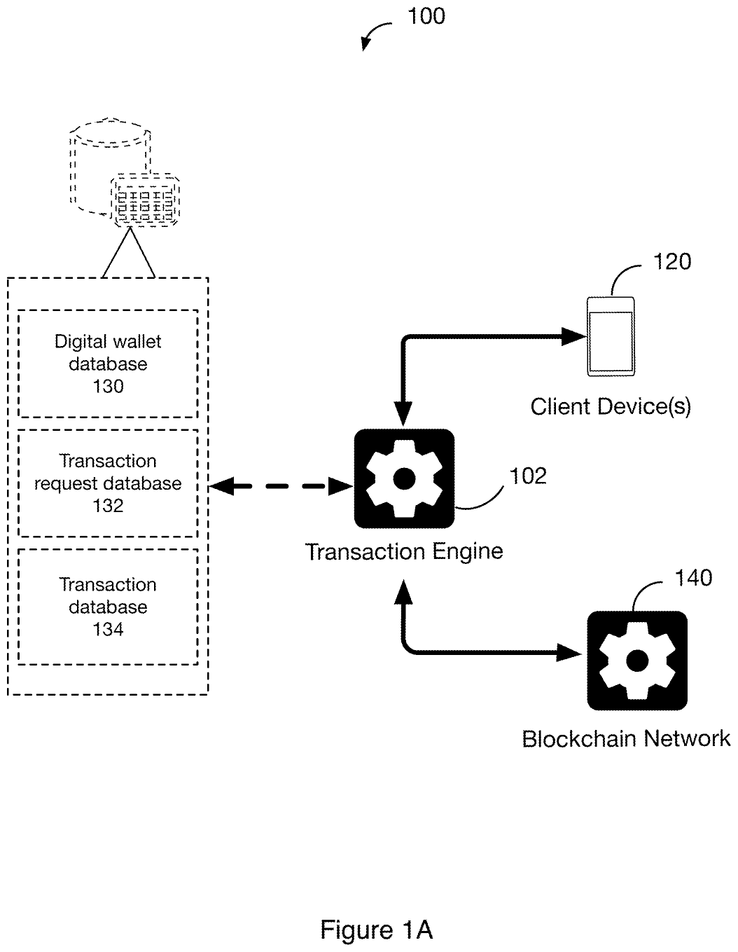

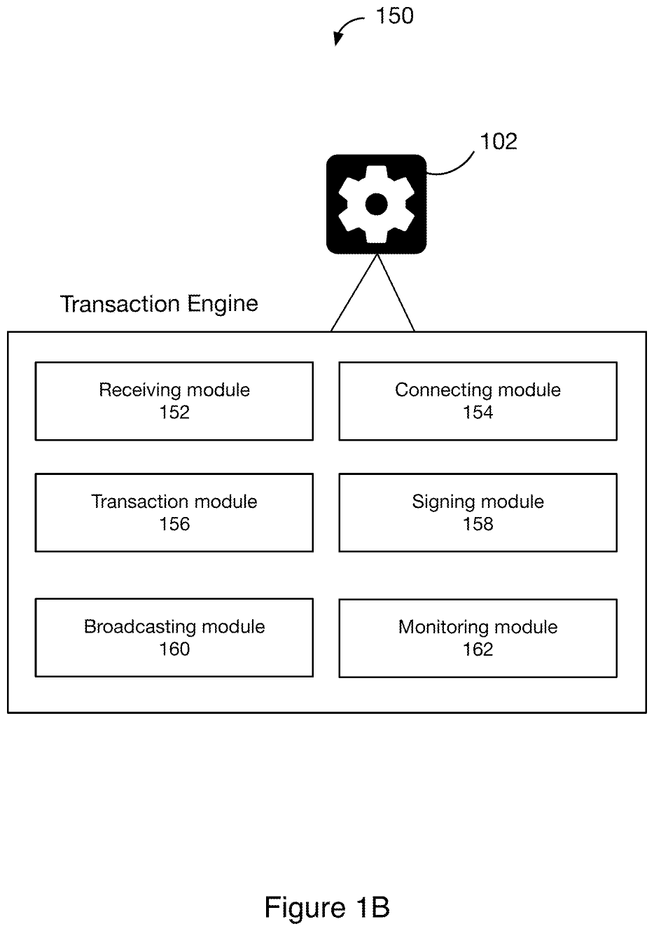

FIG. 1A is a diagram illustrating an exemplary environment in which some embodiments may operate. In the exemplary environment 100, one or more client device(s) 120 are connected to a transaction engine 102. The transaction engine 102 is connected to a blockchain network 140 for the purposes of broadcasting and completing UTXO-based transactions, and optionally connected to one or more database(s), including a digital wallet database 130, transaction request database 132, and/or transaction database 134. One or more of the databases may be combined or split into multiple databases. The transaction engine and/or client device(s) in this environment may be computer devices or hosted on computer devices.

The exemplary environment 100 is illustrated with only one transaction engine, one blockchain network, and one client device for simplicity, though in practice there may be more or fewer instances of each. In some embodiments, one or more of these components may be part of or hosted on the same computer or device.

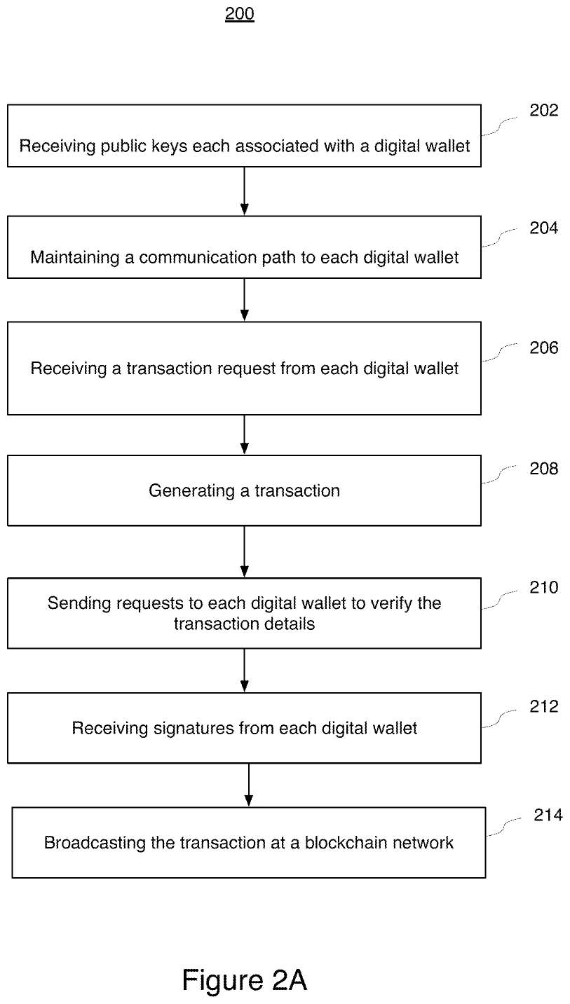

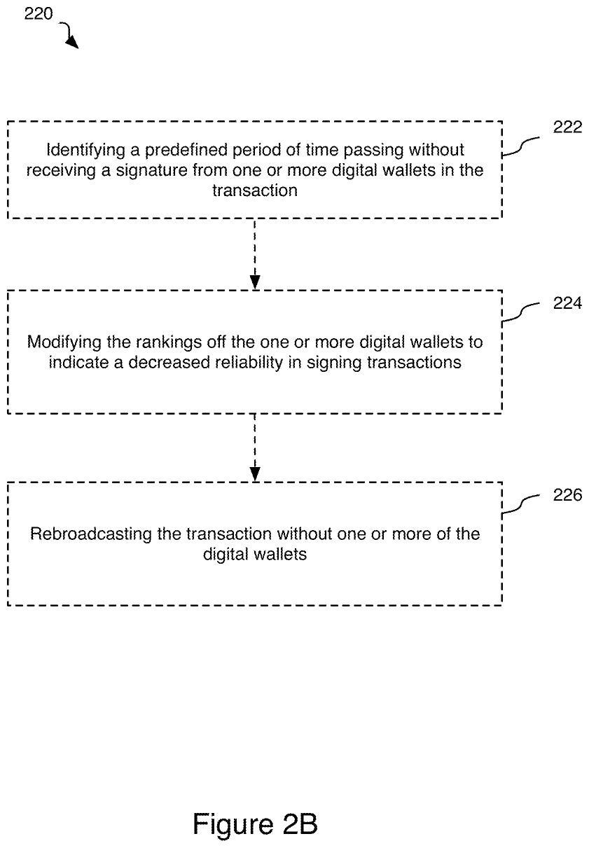

In one embodiment, the transaction engine 102 may perform the method 200 (FIG. 2A) or other method herein and, as a result, provide batch processing of blockchain-based, UTXO-based transactions. A UTXO refers to an amount of digital currency left remaining after a cryptocurrency transaction has been executed. UTXOs are processed continuously, and are responsible for beginning and ending each transaction. When a transaction is completed, any unspent outputs are deposited back into a database as inputs which can then be used at a later date for a new transaction. UTXOs cannot be exchanged for custom amounts; the entire amount of a given UTXO stored must be spent. UTXOs are only present in some cryptocurrencies, such as, e.g., Bitcoin, Bitcoin Cash, and Litecoin. Such currencies will be designated as “UTXO-based” for the purposes described herein. Other cryptocurrencies may not be built around processing and exchanging UTXOs. Ethereum, for example, is built on an “account-based” model rather than a UTXO-based model, and has comparatively more similarities to a traditional banking account model. The transaction engine 102 functions to facilitate the batch processing of transactions involving UTXO-based cryptocurrencies, not account-based or other cryptocurrencies.

In some embodiments, this batch processing may be accomplished via communication with client device(s), blockchain network, or other components of the system over a network. In some embodiments, the transaction engine 102 is an application hosted on a computer or similar device, or is itself a computer or similar device configured to host an application to perform some of the methods and embodiments herein.

Client device(s) 120 are devices with a display configured to present information to a user of the device and send or receive data on behalf of the user of the device. The user may be an individual person acting on behalf of only themselves or a representative acting on behalf of an entity such as, e.g., a business organization. In some embodiments, the client device 120 presents information in the form of a user interface (UI) with UI elements or components. In some embodiments, the user interacts with the UI to connect to the transaction engine 102 or a server hosting the transaction engine 102, and send a transaction request including a desired destination of the transaction and the amount of cryptocurrency value to be transacted. In some embodiments, the client device 120 sends and receives signals and/or information to the transaction engine 102. In some embodiments, the client device 120 is a computing device capable of hosting and executing one or more applications or other programs capable of sending and/or receiving information. In some embodiments, the client device 120 may be a computer desktop or laptop, mobile phone, virtual assistant, virtual reality or augmented reality device, wearable, or any other suitable device capable of sending and receiving information. In some embodiments, the transaction engine 102 may be hosted in whole or in part as an application or web service executed on the client device 120.

Optional database(s) 130 may include one or more of a digital wallet database 130, transaction request database 132, and/or transaction database 134. These database(s) function to store and/or maintain, respectively, digital wallet or keychain information; received transaction requests; and pending transactions and their associated transaction details. The optional database(s) may also store and/or maintain any other suitable information for the transaction engine 102 to perform elements of the methods and systems herein. In some embodiments, the optional database(s) can be queried by one or more components of system 100 (e.g., by the transaction engine 102), and specific stored data in the database(s) can be retrieved. In some embodiments, some or all elements of database(s) 130 will reside on private servers.

Blockchain network 140 is a distributed digital ledger of data that is shared among a network of independent parties. When a user or entity within the blockchain network wants to add a record, or “transaction”, to a blockchain, users and entities in the blockchain with validation control verify the proposed transaction. In this fashion, blockchains are peer-to-peer systems wherein data integrity is maintained through a large distributed network. Components within a given blockchain include a block, or list of transactions recorded into a ledger over a given period; a chain, or hash that links one block to another; and a network composed of full nodes, with each node containing a complete record of all the transactions recorded within the blockchain. These transactions can record not only the details of any exchanged value but also any associated data payload linked to the transactions. UTXO-based cryptocurrencies, such as Bitcoin, involve transactions which are generated (i.e., built) and then broadcasted on the blockchain network. While the blocks associated with transactions are being added to the blockchain, the system can check for confirmation from the blockchain network as to whether the transaction has been recognized by the network but not initiated, the broadcasting has initiated but not yet completed, or the broadcasting has completed.

FIG. 1B is a diagram illustrating an exemplary computer system 150 with software modules that may execute some of the functionality of the transaction engine 102. This functionality is described herein.

Receiving module 152 functions to receive information and data from one or more components of the system, including, e.g., receiving public keys which are associated with digital wallets and sent from client devices, transaction requests sent from client devices, and/or digital wallet or keychain information received from a digital wallet database.

Connecting module 154 functions to connect with client devices or servers storing digital wallets and maintain communication paths with those digital wallets. In some embodiments, the communication path maintained with a given digital wallet is an asynchronous connection with respect to the communication paths maintained with other digital wallets.

Transaction module 156 functions to generate a transaction based on received transaction requests from multiple digital wallets.

Signing module 158 functions to send a request to each digital wallet in the transaction to verify the transaction details for that digital wallet. Signing module 158 also functions to process received signatures or notifications of received signatures pertaining to each digital wallet in the transaction.

Broadcasting module 160 functions to broadcast the generated transaction at a blockchain network.

Monitoring module 162 functions to monitor the blockchain network in order to check for confirmation that a broadcast transaction has completed.

The above modules and their functions will be described in further detail in relation to an exemplary method below.

Various aspects of this exemplary embodiment will be described in further detail in relation to an exemplary method below.

II. Exemplary Method

FIG. 2A is a flow chart illustrating an exemplary method that may be performed in some embodiments.

At step 202, the system receives a number of public keys each associated with a cryptocurrency-based digital wallet or keychain. In some embodiments, any digital wallet with public and private key pairs can be used. In some embodiments, the digital wallet is a hierarchical deterministic wallet or keychain (“HD wallet”), i.e., a cryptocurrency-based digital wallet or keychain that hierarchically derives its private keys (“HD keys”) from a seed. Such HD wallets function by randomly generating private keys on the fly from a seed, and may operate by deriving all addresses (i.e. public and private key pairs) from a single recovery seed. Private keys may be stored offline, allowing for the possibility of deriving the entire tree of public keys from a parent public key without needing any private keys. Thus, each received HD key may be seen as a key to a large keychain, wherein a hierarchy of keys can always be generated from a parent public key in a deterministic manner. The result is that, using the HD wallet, an unbounded number of key pairs can be generated to manage UTXO-based cryptocurrency transactions, with those key pairs always being able to be recovered from just the root key being used for the wallet.

In some embodiments, the use of HD wallets over non-HD wallets can lead to (1) increased privacy and (2) increased wallet flexibility for users. First, using new addresses for all change outputs increases privacy, since calculating the balance of a particular wallet becomes non-trivial for outside third parties due to the wallet funds being split among multiple addresses rather than being located within a single address. Second, use of HD wallets can enable increased wallet flexibility, including a “deposit address” feature whereby a new address is generated and given out to a third party. This particular address can then be monitored for incoming funds, and the client can be notified of a confirmed deposit. This can be useful for enterprise or business use cases such as, e.g., a centralized exchange receiving deposits, an instant exchange performing a swap, and an online store receiving payment for a product.

In some embodiments, the system receiving the public key is part of a registration process for the digital wallet. Upon receiving the public key, the digital wallet is entered to be registered within the transaction engine or at a transaction server hosting the engine. Registration of a digital wallet signals that the wallet should be included in the next transaction. In some embodiments, registration for a given upcoming transaction is available for a set, specific period of time before closing and becoming unavailable. Once that time has elapsed, any user wishing their digital wallet to be entered into a transaction will have to wait for the next transaction registration period to begin.

At step 204, the system maintains, using the public keys, a communication path to each digital wallet. In some embodiments, this effectively means that the system has registered the digital wallet for inclusion as an input in the upcoming transaction to be generated. In some embodiments, the communication path is maintained such that strictly the client maintains the private key, and neither the transaction engine nor server hosting the transaction engine receive access to any of the funds within the digital wallet. The communication path is established to manage and coordinate all included wallets within the upcoming transaction. In some embodiments, the system maintains an asynchronous communication path for wallets with respect to the other wallets included in or registered for the transaction.

In some embodiments, the server hosting the transaction engine is a centralized server. The centralized server functions in coordination with the transaction engine to maintain the communication paths with the digital wallets.

At step 206, the system receives a transaction request from each digital wallet. The transaction request includes one or more details of the request transaction, including, e.g., the input (e.g., address of the digital wallet sending the funds), the output (e.g., destination address designated as an intended recipient of the transaction funds), a designated cryptocurrency, and a value in that cryptocurrency intended to be sent to the destination.

In some embodiments involving a centralized server maintaining communication with the digital wallets, the server periodically (e.g., once every hour or every two hours) collects together these transaction requests to be sent out. In some embodiments, the system receiving the transaction requests optimizes the upcoming transaction to be generated to make the transaction more efficient and less costly. In some embodiments, the system splits up the fees such that each person or entity participating in the transaction is paying their fair share according to the amount of space they represent in the transaction including, e.g., how many outputs they designate in the transaction request. In some embodiments, the system additionally apportions the fee such that each person or entity pays only their share of the overhead. In this way, people and entities registered in the transaction will receive discounts due to the bundling up of transactions with other people/entities into one aggregate transaction.

In some embodiments, the transaction request from one or more wallets includes a target output amount, wherein the transaction request specifies what its target unspent output number should be for the transaction. The system then ensures that the wallet has that target number of UTXOs remaining and available whenever the system generates a transaction. An entity can thus control the velocity of transactions per hour. For example, a wallet may wish to have 6 unspent outputs available, because the entity wishes to send a transaction 6 times per hour and knows that transactions will typically take approximately 10 minutes to confirm, but sometimes will take up to 30 minutes. This entity does not wish to be left in a situation where no transaction can be sent because all available UTXOs in the wallet have been used. The system can receive the target unspent output number, analyze the 6 unspent outputs, select 3 of those outputs for the next transaction, and recreate 3 more UTXOs in the leftover change for those transactions in order to recreate the amount of unspent UTXOs that existed (i.e., 6 UTXOs). In this way, the availability of an entity's wallet can be maintained such that the wallet is never locked up and unavailable for an extended period of time, which can occur if all of a wallet's available UTXOs are spent on a single transaction.

At step 208, the system generates the transaction. The transaction being built up and generated includes the various transaction details (e.g., inputs, outputs, and cryptocurrency value to be transacted) pertaining to each individual transaction request to be included in the transaction. The system thus collects the transaction requests from all digital wallets registered for including in the transaction, then aggregates them within a generated batch transaction. This batch transaction involves multiple outputs, with the multiple outputs being associated with one or more additional digital wallets, i.e., the destination addresses designated in the transaction requests. In some embodiments, the system generates a list of transaction requests based on the received requests, and the list of transaction requests is then used to generate the transaction.

In some embodiments, the system identifies one or more of the outputs having a shared destination, and merges the outputs into a single output associated with the shared destination. This is performed to provide an efficient and less costly transaction.

At step 210, the system sends requests to each digital wallet to verify the transaction details. In some embodiments, the server and/or transaction engine continues to asynchronously maintain communication with the digital wallets registered for the transaction. The system sends out requests to each of these registered digital wallets to verify the transaction details, in order to ensure the authenticity and veracity of the transaction. In some embodiments, these requests are sent by the system at a periodic time interval, e.g., once every 10 minutes or once every hour. In some embodiments, the requests are sent upon a triggering condition, such as upon a capacity for the transaction being reached. Such capacity may be a technological capacity based on the transaction limits, requirements, and constraints of the cryptocurrency being transacted.

At step 212, the system receives signatures or notifications of signatures from each digital wallet. In some embodiments, the server and/or transaction engine maintains an asynchronous connection with the registered digital wallets, and these registered digital wallets are then configured to automatically sign the transaction upon receiving the request to verify the transaction details. Each wallet registered for the transaction must sign in order for the transaction to be valid. A digital wallet may fail to automatically sign if the wallet has, for example, connection issues or other technical problems. A digital wallet may also abort the transaction when a person or entity controlling the wallet chooses to do so deliberately. If one or more wallets do not sign, the transaction as a whole fails. In some embodiments, if a transaction fails, the system can be configured to rebuild the transaction as a new transaction with the same inputs and same outputs as the previous transaction. In some embodiments, the fee to be broadcast may be higher to provide a higher chance of the transaction being completed. In some embodiments, one or more of the wallets failing to sign or aborting the transaction may be removed from the regenerated transaction.

At step 214, the system broadcasts the transaction at a blockchain network. The system prepares the transaction to be broadcast to a blockchain network, for inclusion within that blockchain. All rules and requirements for a transaction to be recognized, added to blocks of the blockchain, and the transaction completing must be followed in order for the transaction to finish.

In some embodiments, the system may send one or more confirmation requests to the blockchain network. The system requests the blockchain node connected to the other peers on the network for the status of the transaction. In some cases, the node may reply that the transaction is not recognized. In some embodiments, the system may respond by rebroadcasting the transaction with the same inputs and outputs. In some cases, the transaction can be dropped from the network and the system must rebroadcast it. In some cases, the node does recognize the transaction, and eventually it may get confirmed and added to a block on the chain. The system may then periodically monitor the transaction until a specified number of blocks have been added (e.g., 3 or 6 blocks, or the full number of blocks required for the transaction) by which the system determines that a transaction has been completed. In some embodiments during this confirmation stage, if the blocks have not been confirmed to be added over a sufficient amount of time, the system may opt to rebroadcast the transaction with an increased transaction fee. All digital wallets must then sign the updated version with the higher fee all over again. The system then monitors that transaction to completion. In a congested network, such rebroadcasting and monitoring may occur several times before a transaction is completed.

FIG. 2B is a flow chart illustrating additional steps that may be performed in accordance with some embodiments.

At optional step 222, the system identifies a predefined period of time passing without receiving a signature from one or more digital wallets in the transaction. The system is configured such that each digital wallet is associated with a “ranking”, e.g., a score, percentage, listing, comparison, or other metric, representing the reliability of the digital wallet in signing transactions. Every time a digital wallet participates in a transaction and signs the transaction, the ranking can be increased to indicate the wallet is a reliable signer. If a digital wallet does not sign due to a lost connection or other issue, the ranking can be decreased to indicate the wallet is less reliable. This is because the wallet has held up every other wallet in completing the transaction, so ranking penalties accrue. In some cases, people or entities associated with wallets may be intentional malicious actors attempting to, for example, purposefully slow down the system. In such cases, ranking penalties will continue to accrue as the malicious actor continues to operate until that actor is removed from rebroadcasted transactions and, eventually, all future transactions within the system. In some embodiments, all entities and wallets which are new to the system (i.e., have no history of transactions within the system) are assigned a low ranking, and as the wallet shows ability to sign and operate in a reliable way over time with multiple transactions, the ranking for the wallet is only then increasingly improved. In some embodiments, “signing pools” or groups of wallets assigned within a certain ranking or range of rankings can be established. As a wallet's ranking increases, the wallet can be categorized into better and better signing pools and grouped for transactions with increasingly more reliable wallets also placed in those signing pools.

At optional step 224, the system modifies the rankings of the one or more digital wallets to indicate a decreased reliability in singing transactions, as described above.

At optional step 226, the system rebroadcasts the transaction without one or more of the digital wallets. In some embodiments, once the transaction fails due to failure of one or more wallets to sign, those wallets receive decreased rankings accordingly. If the ranking is sufficiently low for a wallet, then the wallet may be removed from the rebroadcast transaction based on thar ranking. In some cases, the wallet may additionally be removed from one or more future transactions, or even removed from the system as a whole as wallet which can be accepted for registration for future transactions.

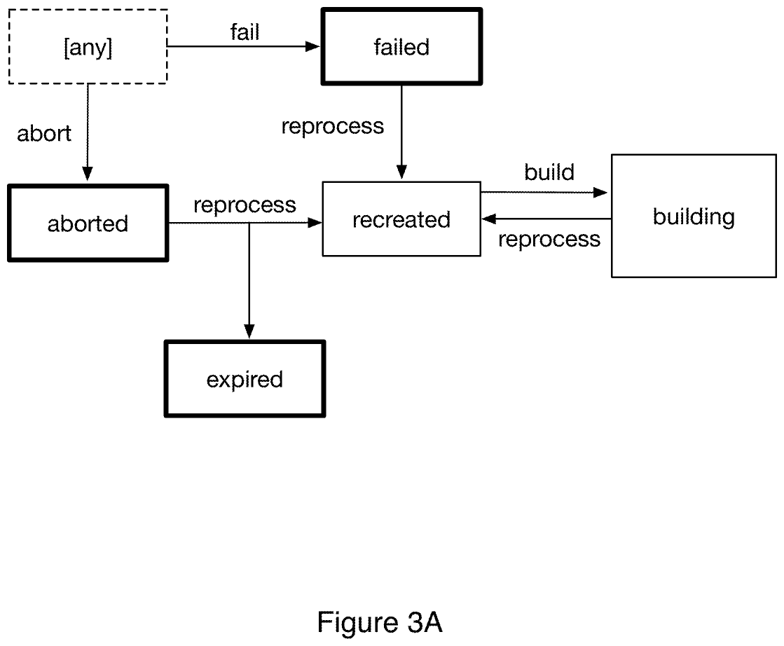

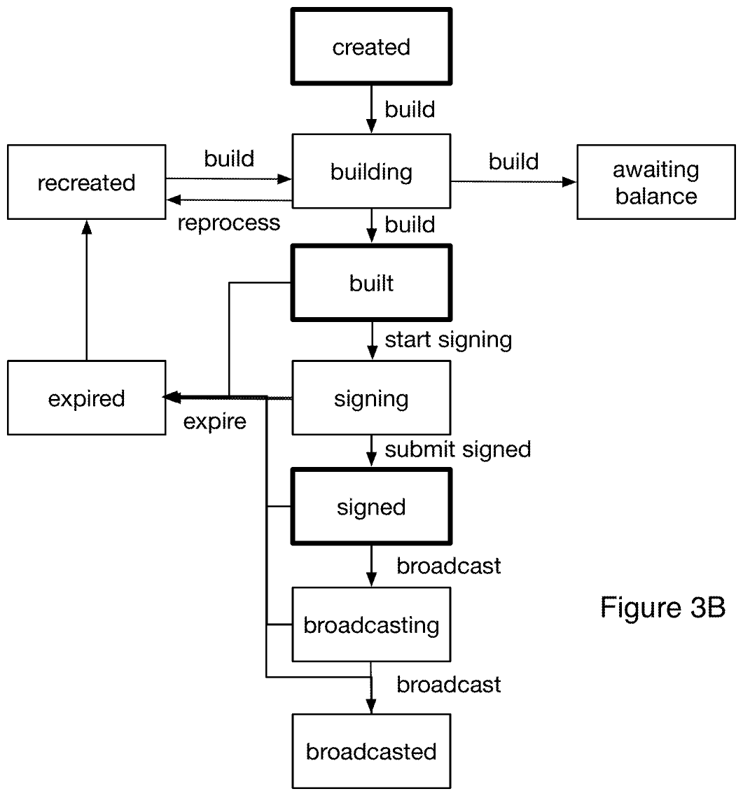

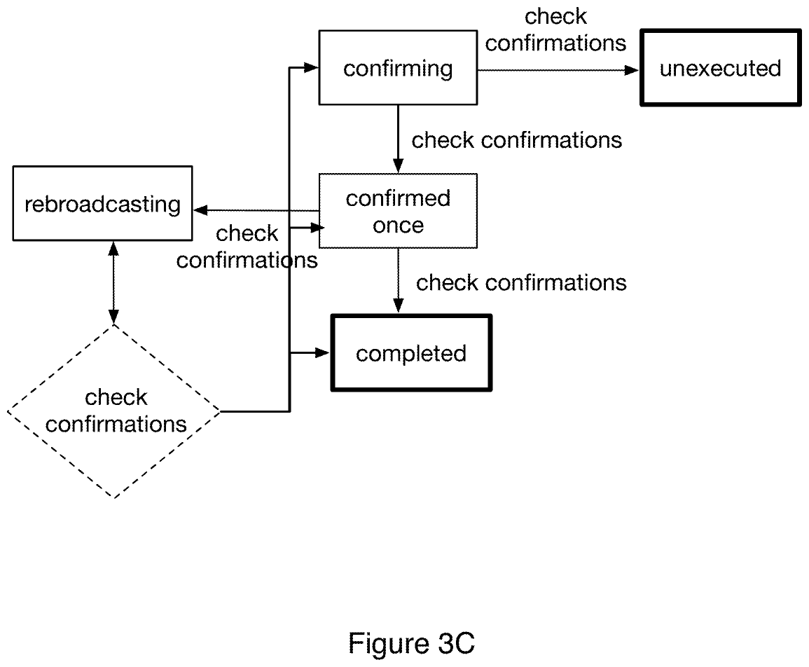

FIG. 3A is a flow chart illustrating an example flow for generating a new transaction after a failed or aborted attempt to complete a transaction, in accordance with some embodiments. At the top left of the flow chart, any of the digital wallets registered for a transaction may potentially fail to sign the transaction, or deliberately choose to abort the transaction. In either case, the transaction can be reprocessed once it fails. During that reprocessing phase, the system may select to recreate the transaction with the same inputs and same outputs, and send requests to reprocess the transaction to each of the registered wallets. In some embodiments, the system may recreate the transaction without one or more inputs/outputs associated with wallets that have received sufficiently decreased rankings to be excluded from the rebroadcasted transaction. In some embodiments, if a wallet does not reply to a request for reprocessing the transaction in sufficient time, then the request expires with respect to that wallet, and the wallet is not included in the rebroadcast transaction. The system proceeds with building a transaction, reprocesses again if necessary, and then moves on to other steps in the process, including requesting verification from the wallets. The process repeats in the event of a wallet failing to sign or aborting that rebroadcast transaction.

FIG. 3B is a flow chart illustrating an example flow for generating and successfully broadcasting a transaction, in accordance with some embodiments. One example flow is illustrated as a potential flow from creating an upcoming transaction through completion of broadcasting. In the example, an upcoming transaction is created as public keys are received from digital wallets to be included in the upcoming transaction. The system builds the transaction by aggregating transaction requests from these registered wallets as they come in.

In some cases, the system may await a balance from one or more wallets. That is, when a client wallet requests a transaction, the balance of the input address is checked to ensure sufficient funds are present to cover the output as well as the fees. In the case the balance is insufficient, the transaction request is set to await the balance, and will not be included in the next batch transaction. The input address is monitored, and once it reaches a sufficient balance, it can then be included in the next batch. If a set period of time passes and the input address still has an insufficient balance, the transaction request will expire and will no longer be considered until the client explicitly requests the transaction again.

In some cases, the transaction will need to be reprocessed and rebuilt, such as when one or more wallets drop out or abort the transaction while it is still being built. Upon successfully building the transaction, requests for signature go out to the individual wallets. If the requests are not signed by one or more wallets, then the signing expires, and the transaction must be recreated and rebuilt. If all wallets registered in the transaction sign, then the system broadcasts the transaction to the blockchain network. In some embodiments, a monitoring and confirmation stage occurs, as will be illustrated in the example of FIG. 3C. If the broadcasting is successful, then the transaction is broadcasted on the public blockchain and the transaction is completed.

FIG. 3C is a flow chart illustrating an example flow for confirming that a transaction has been completed, in accordance with some embodiments. At the “confirming” stage, the system checks confirmations by requesting a confirmation status from a suitable node of the blockchain network. If a sufficient time has passed and the blockchain network indicates that the transaction is as yet unexecuted, then then system may rebroadcast the transaction with a higher fee. If the system receives confirmation that one block is added, then it may wait and continue to check for confirmation on a periodic basis. If a sufficient time has passed without further added blocks, then the system may rebroadcast and then check for confirmations once more. If the system receives confirmation that a sufficient number of blocks have been added, then the system may determine that the transaction has been completed.

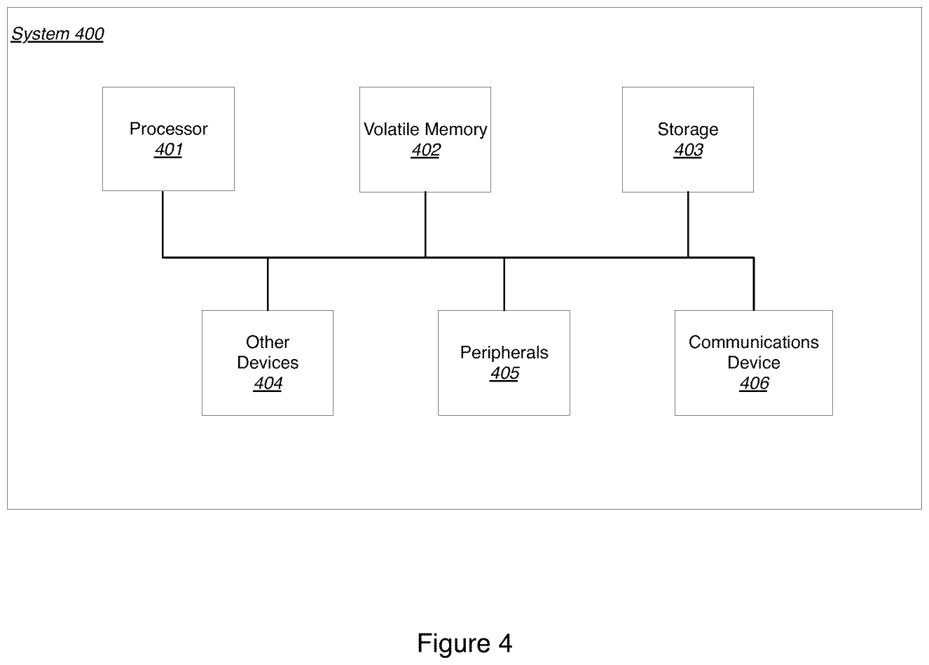

FIG. 4 is a diagram illustrating an exemplary computer that may perform processing in some embodiments. Exemplary computer 400 may perform operations consistent with some embodiments. The architecture of computer 400 is exemplary. Computers can be implemented in a variety of other ways. A wide variety of computers can be used in accordance with the embodiments herein.

Processor 401 may perform computing functions such as running computer programs. The volatile memory 402 may provide temporary storage of data for the processor 401. RAM is one kind of volatile memory. Volatile memory typically requires power to maintain its stored information. Storage 403 provides computer storage for data, instructions, and/or arbitrary information. Non-volatile memory, which can preserve data even when not powered and including disks and flash memory, is an example of storage. Storage 403 may be organized as a file system, database, or in other ways. Data, instructions, and information may be loaded from storage 403 into volatile memory 402 for processing by the processor 401.

The computer 400 may include peripherals 405. Peripherals 405 may include input peripherals such as a keyboard, mouse, trackball, video camera, microphone, and other input devices. Peripherals 405 may also include output devices such as a display. Peripherals 405 may include removable media devices such as, e.g., hard drives, solid state drives, or flash drives. Communications device 406 may connect the computer 100 to an external medium. For example, communications device 406 may take the form of a network adapter that provides communications to a network. A computer 400 may also include a variety of other devices 404. The various components of the computer 400 may be connected by a connection medium such as a bus, crossbar, or network.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A method for providing batch processing of blockchain-based cryptocurrency transactions, comprising:
receiving or deriving a plurality of public keys each associated with a digital wallet for cryptocurrency;
maintaining, using the public keys, a communication path to each digital wallet;
receiving a transaction request from each digital wallet;
generating a transaction comprising transaction details for each digital wallet, and wherein the transaction further comprises a plurality of outputs associated with additional digital wallets;
sending a request to each digital wallet in the transaction to verify the transaction details for that digital wallet;
receiving a signature from each digital wallet based on the request to verify the transaction details for that digital wallet; and
upon receiving signatures from each of the digital wallets, broadcasting the transaction at a blockchain network.

2. The method of claim 1, wherein the digital wallets associated with the transaction are hierarchically deterministic (HD) wallets, and wherein the public keys associated with the HD wallets are hierarchically derived.

3. The method of claim 2, further comprising:
receiving a plurality of inputs and a plurality of outputs from at least one user associated with an HD wallet, wherein one of the plurality of outputs is assigned as a change output.

4. The method of claim 1, wherein the communication path to each digital wallet is asynchronous, and wherein sending the request to each digital wallet to verify the transaction details is executed asynchronously.

5. The method of claim 1, wherein the transaction details for each digital wallet comprise at least a transaction input associated with the digital wallet, a transaction output associated with one of the additional digital wallets, and a cryptocurrency value to be transacted.

6. The method of claim 1, wherein the transaction details for each digital wallet comprise at least a target output amount specifying a target unspent output number for the transaction.

7. The method of claim 1, wherein sending the request to each digital wallet in the transaction to verify the transaction details is performed at a periodic time interval.

8. The method of claim 1, wherein sending the request to each digital wallet in the transaction to verify the transaction details is performed upon a transaction capacity being reached.

9. The method of claim 1, further comprising:
generating a list of transaction requests based on the transaction requests for each digital wallet, wherein the list of transaction requests is used to generate the transaction.

10. The method of claim 1, wherein generating the transaction comprises:
identifying one or more of the plurality of outputs having a shared destination, and
merging the one or more of the plurality of outputs into a single output associated with the shared destination.

11. The method of claim 1, further comprising:
apportioning fees for the transaction to the digital wallets associated with the transaction requests, wherein the fees are shared proportionally among the digital wallets according to the amount of transaction space used.

12. The method of claim 1, wherein each digital wallet is associated with a ranking representing the reliability of the digital wallet in signing transactions.

13. The method of claim 12, further comprising:
upon a predefined period of time passing without receiving a signature from a digital wallet in the transaction, modifying the ranking of the digital wallet to indicate a decreased reliability of the digital wallet in signing transactions.

14. The method of claim 12, further comprising:
removing one or more digital wallets from future transactions based on their associated rankings.

15. The method of claim 12, further comprising:
upon receiving a signature from a digital wallet in the transaction, modifying the ranking of the digital wallet to indicate an increased reliability of the digital wallet in signing transactions.

16. The method of claim 12, further comprising:
upon a predefined period of time passing without receiving a signature from one or more of the digital wallets in the transaction, rebroadcasting the transaction with a higher transaction fee.

17. The method of claim 1, wherein receiving the signature from each digital wallet comprises:
sending a status request for the transaction to the blockchain network, and
receiving a response from the blockchain network that all transaction blocks have been recorded in the blockchain.

18. A non-transitory computer-readable medium containing instructions for providing batch processing of blockchain-based cryptocurrency transactions, comprising:
instructions for receiving or deriving a plurality of public keys each associated with a digital wallet for cryptocurrency;
instructions for maintaining, using the public keys, a communication path to each digital wallet;
instructions for receiving a transaction request from each digital wallet;
instructions for generating a transaction comprising transaction details for each digital wallet, and wherein the transaction further comprises a plurality of outputs associated with additional digital wallets;
instructions for sending a request to each digital wallet in the transaction to verify the transaction details for that digital wallet;
instructions for receiving a signature from each digital wallet based on the request to verify the transaction details for that digital wallet; and
upon receiving signatures from each of the digital wallets, instructions for broadcasting the transaction at a blockchain network.

19. The non-transitory computer-readable medium of claim 18, wherein the digital wallets associated with the transaction are hierarchically deterministic (HD) wallets, and wherein the public keys associated with the HD wallets are hierarchically derived.

20. The non-transitory computer-readable medium of claim 18, wherein the communication path to each digital wallet is asynchronous, and wherein sending the request to each digital wallet to verify the transaction details is executed asynchronously.
